(19) United States
(12) Patent Application Publication
(10) Pub. No.: US 2003/0231182 A1
(43) Pub. Date: Dec. 18, 2003

(54) Virtual character control system and method and recording medium

(76) Inventors: Tae-Joon Park, Daejeon (KR); Chang-Woo Chu, Daejeon (KR); Soon-Hyoung Pyo, Daejeon (KR); Byoung-Tae Choi, Daejeon (KR); Seong-Won Ryu, Daejeon (KR); Hang-Kee Kim, Daegoo (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/417,484

(22) Filed: Apr. 17, 2003

(30) Foreign Application Priority Data
Jun. 12, 2002 (KR) 2002-77324

(51) Int. Cl. G06T 15/70

(52) U.S. Cl. 345/474

(57) ABSTRACT

In a virtual character control system, a character form mesh linked to articulation information of a character including articulations and at least one item mesh linked to the articulation information are stored in a set format. A temporary mesh generator selects an item mesh attached to the character from among the at least one item mesh according to item removal information, and combines the selected item mesh and the character form mesh to generate a temporary mesh. A character motion controller performs mesh skinning on the temporary mesh according to character motion control information to link the character form mesh and the item mesh to the character motion control information, thereby very effectively controlling motion of the virtual character.

### CROSS REFERENCE TO RELATED APPLICATION

This application is based on Korea Patent Application No. 2002-77324 filed on Dec. 6, 2002 in the Korean Intellectual Property Office, the content of which is incorporated herein by reference.

### BACKGROUND OF THE INVENTION

(a) Field of the Invention

The present invention relates to a system and method for controlling virtual characters.

(b) Description of the Related Art

In the categories of 3-dimensional (3-D) game services or various virtual community application services, many services are provided on the basis of generation of 3-D virtual characters, attachment and removal of various items, and changes/putting on of clothes.

Conventionally, high-speed rendering processing has been applied to expensive graphic workstations or 3-D video game machines, but as high-performance graphic acceleration boards have been installed in personal computers (PCs) as defaults because of development of hardware techniques, general-purpose PCs have come to perform high-speed rendering processing. Accordingly, requirements for new application programs using high-speed rendering processes have increased.

In prior art, methods for controlling hierarchical virtual character motion have been applied to motion control of the characters, and methods for extracting a transform matrix and applying the same have been employed for item removal control.

FIG. 1 briefly shows a conventional method for controlling motion of hierarchical virtual characters, extracting a transform matrix, and applying it; FIG. 2 shows a conventional method for controlling motion of hierarchical virtual characters; and FIG. 3 shows a conventional method for extracting a transform matrix and applying the same.

As shown in FIG. 1, a conventional hierarchical virtual character controller 11 controls motion of a virtual character using articulation information 22 of a 3-D virtual character and part-based form information 21 according to externally-input part-based motion control information of the character, and generates final form information 24. A transform matrix extractor and applier 12 extracts a transform matrix to be applied to each item from articulation information 22a of the motion-controlled virtual character according to item removal information, and applies the transform matrix to stored item form information 23. Application of the transform matrix to the item form matrix 23 generates item form information 25 linked and controlled by motion of the character. The motion-controlled form information 24 and the item form information 25 linked and controlled by motion of the character are output to a display 13 to thereby control removal of an item and motion of a character.

Referring to FIGS. 2 and 3, a method for controlling motion of the hierarchical virtual character and a method for extracting a transform matrix and applying it will be described in detail.

As shown in FIG. 2, when receiving motion control information for setting translation and rotation of respective articulations, the hierarchical virtual character controller 11 translates and rotates each articulation using articulation information 22 of the virtual character to roughly form a motion 22a of the virtual character, and attaches part-based form information 21 to each articulation to generate form information 24 of the virtual character.

Referring to FIG. 3, the transform matrix extractor and applier 12 extracts information, in the transform matrix form, on rotation and translation of articulations linked with the respective items from the articulation information 22a of the motion-controlled virtual character. The extracted transform matrix is applied to corresponding item form information 23 to determine position or rotation of the item. The position or rotation determined item form information 25 and the form information 24 is combined to become a final mesh 26, and the mesh 26 is output to a screen.

However, the above-noted methods were employed when high-speed graphic accelerators have not yet been developed, and usage of the methods has many restrictions on form structuring of the virtual character. In particular, the motions generated according to the above methods are not natural, and control to attach and remove the items is problematically performed though a very complex process.

Therefore, mesh skinning methods for enabling realistic motion control of virtual characters have been developed and applied to the cases of using hardware in which a high-performance graphic accelerator is installed.

FIG. 4 shows a mesh skinning method, and FIG. 5 shows a process for controlling articulations according to the mesh skinning method.

As shown in FIG. 4, in the mesh skinning method, articulation information of the virtual character and a form mesh 41 linked to it are stored altogether. Also, differing from the hierarchical control method for generating a mesh for each part of the character, the whole body of the character is formed with a single mesh. In this instance, the mesh for structuring the form of a character is linked to at least one articulation from a structure of articulations assigned together with it. A mesh skinning performer 31 performs mesh skinning on articulation information and the form mesh 41 linked with it according to externally input articulation motion control information. In this instance, each vortex on the mesh is translated and rotated under the influence of translation or rotation of an articulation linked with it to modify the form mesh 41. Hence, controlled form information 42 is displayed as a final form by a display 32.

In the case of modifying the mesh, position information generated by translation and rotation of all articulations linked with each vortex is averaged with a predetermined weight with respect to each articulation, and added to determine a final modification position. As shown in FIG. 5, a mesh form is controlled according to first articulation information in step S51, a mesh form is controlled according to second articulation information in step S52, and the controlled mesh forms are added with weights according to each articulation information set to generate a final mesh in step S53.

However, since it is required to control all vortex coordinates of meshes representing a form of a virtual character one by one so as to control motion in the case of using the mesh skinning method, the motions may not be quickly controlled if there is no support of a hardware device. Also, in order to control item attachment and removal and items linked with motion of the character, a method for extracting a transform matrix and applying it or a method for performing mesh skinning on the mesh including items is required to be applied. Therefore, it is not applicable to application fields that require attachment and removal of items to/from a virtual character.

### SUMMARY OF THE INVENTION

It is an object of the present invention to provide a method for quickly controlling a virtual character.

In order to achieve the object, articulation information of a character is linked with a character form mesh and an item mesh to generate a multiple mesh structure.

In one aspect of the present invention, a character motion control system comprises: a multiple mesh structure storage unit for storing a character form mesh linked to articulation information of the character, and at least one item mesh linked to the articulation information in a set format; a character motion controller for performing mesh skinning according to character motion control information to control an item mesh attached to the character from among the at least one item mesh and control the form mesh; a temporary mesh generator for combining the item mesh attached to the character from among the at least one item mesh with the form mesh according to item removal information to generate a temporary mesh, the character motion controller performing mesh skinning on the attached item mesh and the form mesh with respect to the temporary mesh to control the motion of the character and a position of the attached item; and a display for processing the temporary mesh motion-controlled by the character motion controller, and outputting it to a screen.

The character form mesh is linked to at least one articulation from the articulation information.

In another aspect of the present invention, a character motion control method comprises: (a) storing a character form mesh linked to articulation information of a character and at least one item mesh linked to the articulation information in a set-type multiple mesh structure; (b) selecting an item mesh attached to the character from among the at least one item mesh according to item removal information; and (c) performing mesh skinning according to character motion control information to control the form mesh and the selected item mesh.

The (b) further comprises combining the selected item mesh and the character form mesh to generate a temporary mesh after selecting an item mesh, and (c) further comprises performing mesh skinning on the temporary mesh to control the form mesh and the selected item mesh.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a conventional method for controlling motion of hierarchical virtual characters, extracting a transform matrix, and applying it;

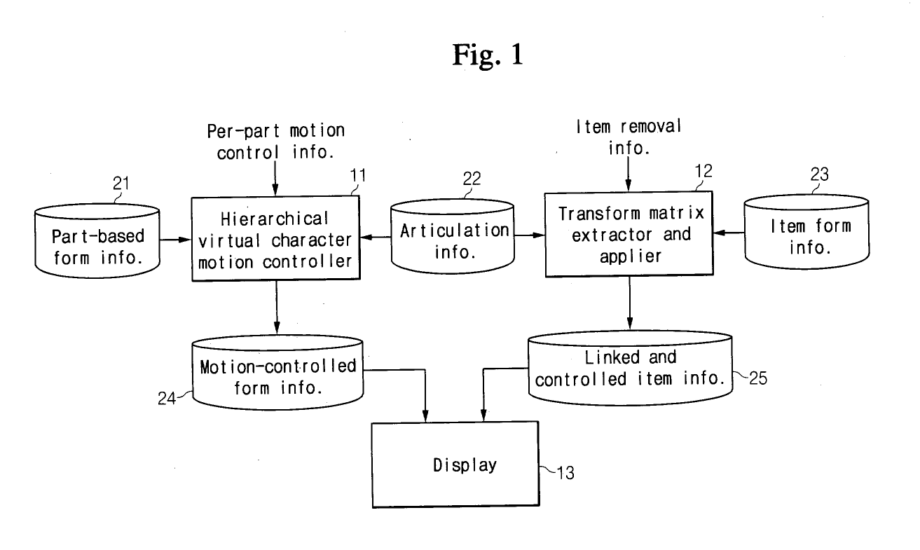

FIG. 2 shows a conventional method for controlling motion of hierarchical virtual characters;

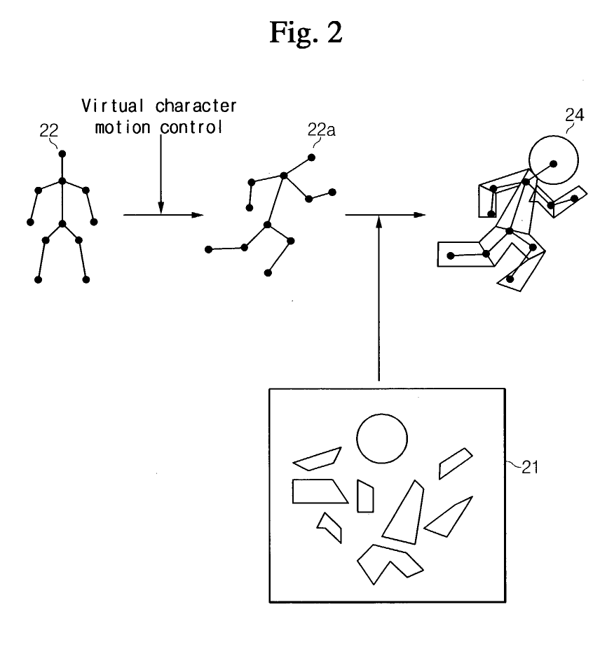

FIG. 3 shows a conventional method for extracting a transform matrix and applying the same;

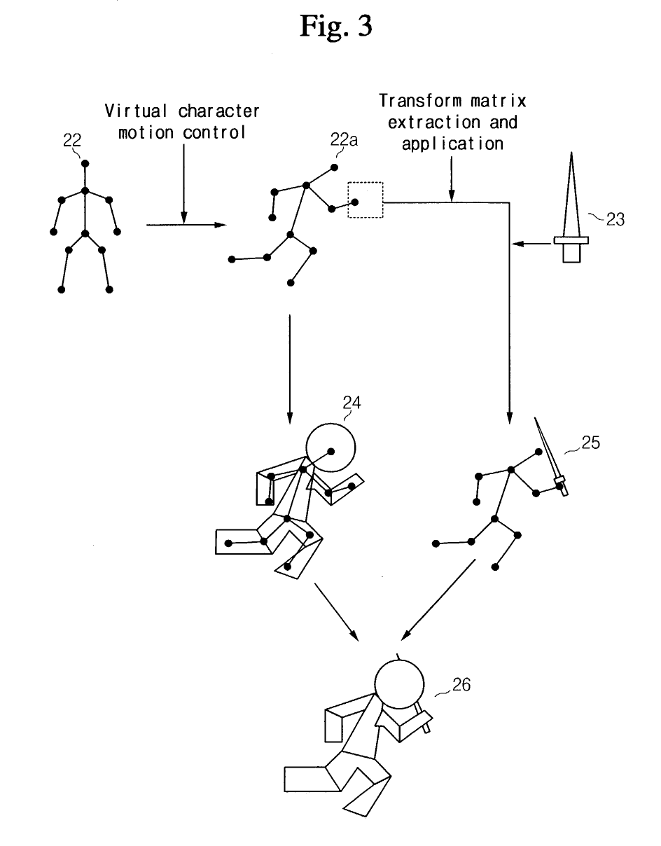

FIG. 4 shows a mesh skinning method;

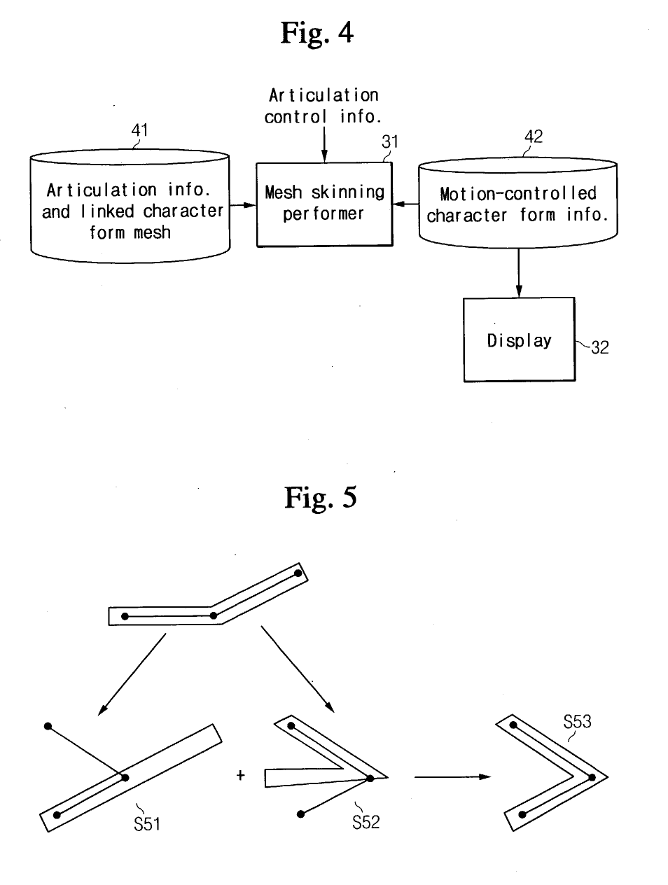

FIG. 5 shows a process for controlling an articulation according to mesh skinning;

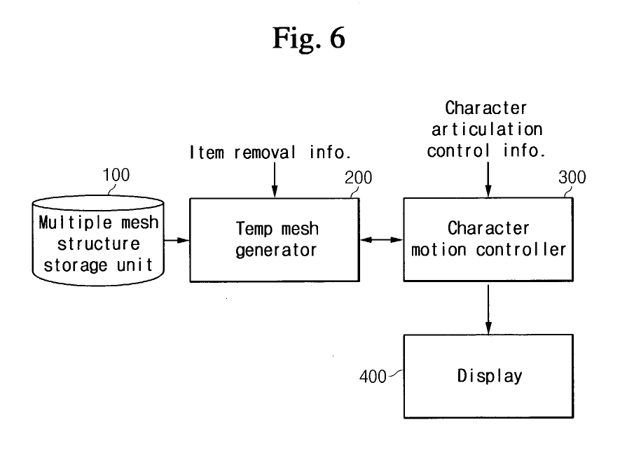

FIG. 6 shows a brief block diagram of a virtual character control system according to a preferred embodiment of the present invention;

FIG. 7 shows a method for generating a multiple mesh structure according to a preferred embodiment of the present invention; and

FIGS. 8 and 9 each show a virtual character control method according to first and second preferred embodiments of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

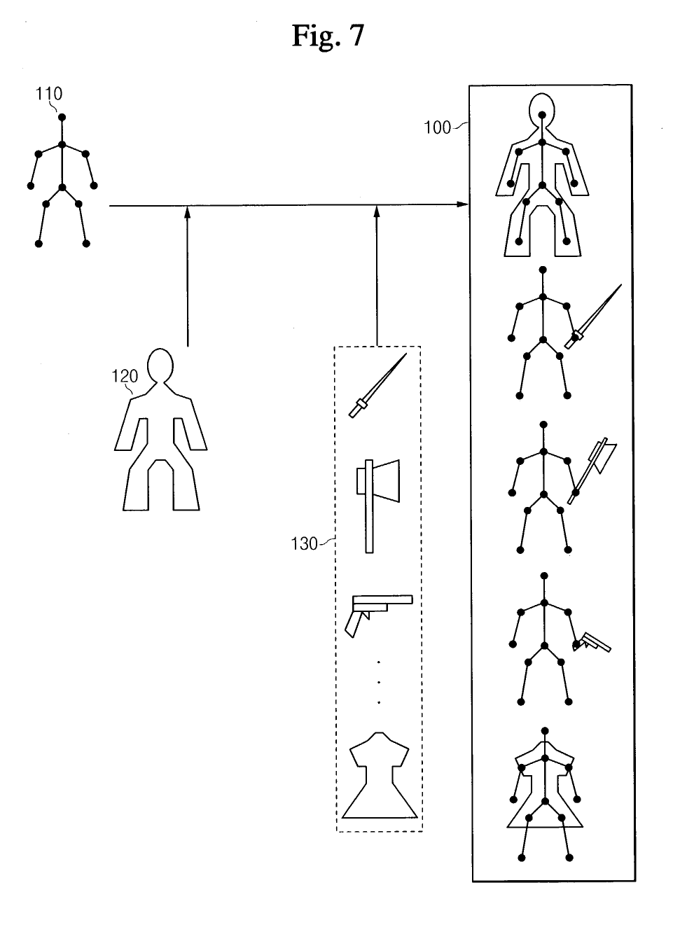

FIG. 6 shows a brief block diagram of a virtual character control system according to a preferred embodiment of the present invention.

As shown, the virtual character control system comprises a multiple mesh structure storage unit 100, a temporary mesh generator 200, a character motion controller 300, and a display 400.

The multiple mesh structure storage unit 100 stores a form mesh of a virtual character and a form mesh of an item used by the virtual character as a single multiple mesh structure together with articulation structure information of the virtual character. In the preferred embodiment of the present invention, the item represents all types of products that may be possessed by the virtual character, including weapons, clothes, food, medicines, and books that may be varied according to usage of the virtual character. The temporary mesh generator 200 selects an item mesh attached to a character from an item mesh according to externally provided item removal information, and combines the selected item mesh and a form mesh of the character to generate a single temporary mesh. The character motion controller 300 applies the mesh skinning method to the temporary mesh, or the character form mesh and the item mesh according to character articulation control information, and generates a translated, rotated, or modified item mesh to be linked with a motion-controlled virtual character form mesh and its motion. The display 400 outputs generated form information to a screen.

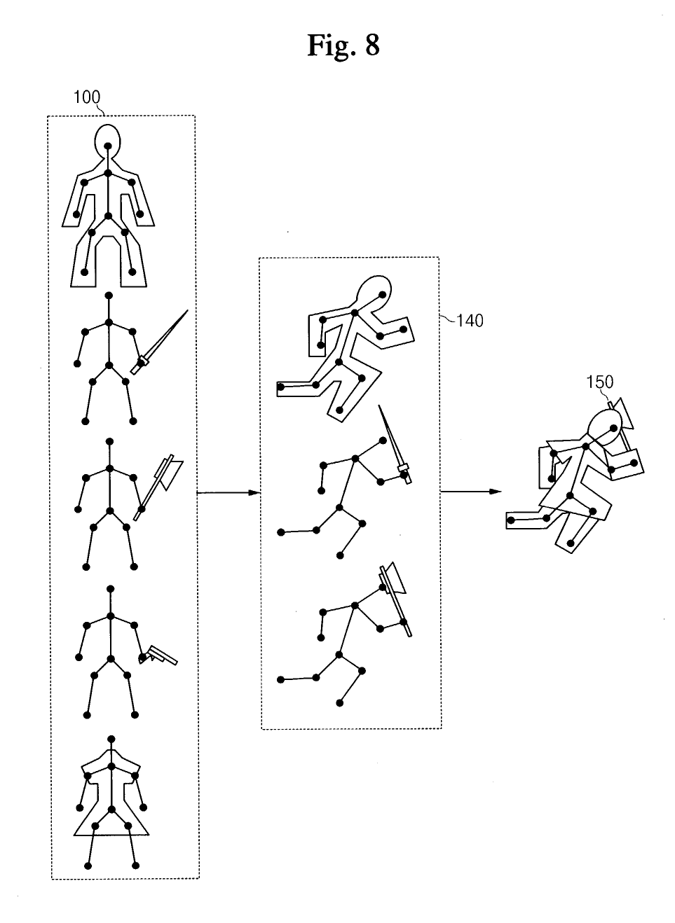

Referring to FIGS. 7 through 9, a method for controlling a virtual character in the virtual character control system will be described in detail.

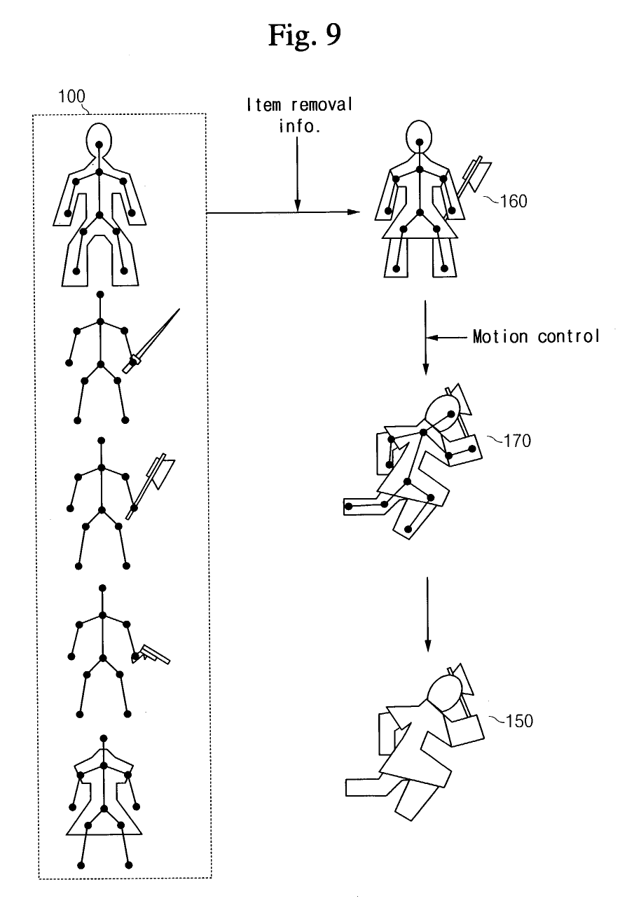

FIG. 7 shows a method for generating a multiple mesh structure according to a preferred embodiment of the present invention, and FIGS. 8 and 9 each show a virtual character control method according to first and second preferred embodiments of the present invention.

As shown in FIG. 7, articulation information 110 of each virtual character is given as basic information for forming a multiple mesh structure, a form mesh 120 for describing form information of a virtual character is given to be linked with articulation information 110 of the virtual character, and the whole body of the character is formed as a single mesh differing from the hierarchical control method for generating a mesh for each part of the character. In this instance, the virtual character form mesh 120 is linked to at least one articulation from among the structure of the articulations assigned together with it.

Form meshes of respective items linked with a virtual character are processed through a method different from the conventional mesh skinning method or the hierarchical virtual character motion control method. That is, an item mesh 130 is linked to the articulation information 110 and stored in a like manner of the virtual character's form mesh 120. In this instance, their linkage is performed so that each item may appropriately react to motion of the articulation related to the item. For example, an item linked to a hand such as a sword or a spear is linked to an articulation concerned with hand motion, and an item such as clothes is linked to an articulation of a body, an arm, or a leg.

Through the above-noted process, the virtual character's form mesh 120 and the item mesh 130 may be controlled by the identical articulation information, and without the conventional transform matrix extraction and application process, item linkage and clothes modification according to character motion is enabled. The form mesh 120 and the item mesh 130 are converted by the identical articulation information 110 into a mesh set format that can be mesh-skinned, and stored in the multiple mesh structure 100.

Referring to FIG. 8, a first preferred embodiment for using the multiple mesh structure 100 to control motion of a virtual character will be described in detail.

As described with reference to FIG. 7, each mesh in the multiple mesh structure 100 may be mesh-skinned according to the identical articulation information. When externally receiving articulation information and item control information for motion control of a character, the character motion controller 300 selects a default character form mesh 120 in the multiple mesh structure 100, an item attached to a character, and a clothes mesh 130 put on by the character to perform mesh skinning. That is, the character motion controller 300 does not apply mesh skinning to all the meshes, but selects an item attached to the character and performs mesh skinning on it. Next, the display 400 combines the mesh-skinned meshes 140 to output a final form 150 to a screen.

According to the first preferred embodiment of the present invention, since the form mesh 120 of the virtual character and the item mesh 130 attached to the virtual character may be controlled by the identical articulation information, the item linkage and modification by the character motion is enabled. However, the mesh skinning must be performed on each output mesh in the first preferred embodiment, and differing from this, a single performance of mesh skinning may control the character, which will be described in detail referring to FIG. 9.

As shown in FIG. 9, in the second preferred embodiment of the present invention, the temporary mesh generator 200 selects an item attached to the character from among the meshes in the multiple mesh structure 100, and combines the item with a form mesh of the character to generate a temporary mesh 160. In this instance, in the temporary mesh 160, all the items to be displayed are combined with form information. Next, the character motion controller 300 applies mesh skinning to the temporary mesh 160 to control motion of the character and link the item according to the control. That is, the character motion controller 300 may control the character's motion and the item by performing mesh skinning once. A motion-controlled and item-controlled form mesh 170 is displayed as a final form 150 by a display 500.

The virtual character control methods according to the first and second preferred embodiments may be realized in a program to be stored in a recording medium including a CDROM, a RAM, a floppy disk, a hard disk drive, or an optical disc. The virtual character control method stored in the above-noted recording media may be processed using a computer.

According to the present invention, since the motion of the virtual character is controlled through a mesh skinning method, the motion of the virtual character is very natural. That is, since the virtual character includes a single mesh and motion of the articulations is generated according to weight-added averages of motion of adjacent articulations in the mesh skinning method, the motion of the virtual character becomes very fluent. Further, since no additional transform matrix extraction and application process is required, the virtual character may be easily controlled, and since an item that is not displayed is not included in the mesh skinning process, very effective calculation management is possible.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A character motion control system comprising:
a multiple mesh structure storage unit for storing a character form mesh linked to articulation information of the character, and at least one item mesh linked to the articulation information in a set format; and
a character motion controller for performing mesh skinning according to character motion control information to control an item mesh attached to the character from among the at least one item mesh and control the form mesh.

2. The system of claim 1, further comprising a temporary mesh generator for combining the item mesh attached to the character from among the at least one item mesh with the form mesh according to item removal information to generate a temporary mesh, the character motion controller performing mesh skinning on the attached item mesh and the form mesh with respect to the temporary mesh to control the motion of the character and a position of the attached item.

3. The system of claim 2, further comprising a display for processing the temporary mesh motion-controlled by the character motion controller, and outputting it to a screen.

4. The system of claim 1, wherein the character form mesh is linked to at least one articulation from the articulation information.

5. A character motion control method comprising:
(a) storing a character form mesh linked to articulation information of a character and at least one item mesh linked to the articulation information in a set-type multiple mesh structure;
(b) selecting an item mesh attached to the character from among the at least one item mesh according to item removal information; and
(c) performing mesh skinning according to character motion control information to control the form mesh and the selected item mesh.

6. The method of claim 5, wherein (b) further comprises combining the selected item mesh and the character form mesh to generate a temporary mesh, and (c) further comprises using the temporary mesh to control the form mesh and the selected item mesh.

7. The method of claim 6, further comprising (d) processing the to controlled temporary mesh as final form image and outputting it to a screen.

8. The method of claim 5, wherein the character form mesh is linked to at least one articulation from among the articulation information.

9. A character motion control system comprising:
a multiple mesh structure storage unit for storing a character form mesh linked to articulation information of the character including a structure of a plurality of articulations, and at least one item mesh linked to the articulation information in a set format;
a temporary mesh generator for selecting an item mesh attached to the character from among the at least one item mesh according to item removal information, and combining the selected item mesh and the character form mesh to generate a temporary mesh; and
a character motion controller for performing mesh skinning on the temporary mesh according to character motion control information to link the character form mesh and the selected item mesh with the character motion control information.

10. A recording medium storing a program including functions comprising:
storing a character form mesh linked to articulation information of a character and at least one item mesh linked to the articulation information in a set-type multiple mesh structure;
selecting an item mesh attached to the character from among the at least one item mesh according to item removal information; and
performing mesh skinning according to character motion control information to control the form mesh and the selected item mesh.

11. The recording medium of claim 10, further comprising selecting the item attached to the character, and combining the selected item mesh and the character form mesh to generate a temporary mesh, and controlling the form mesh and the selected item mesh by performing mesh skinning on the temporary mesh.
